(19) United States
(12) Patent Application Publication
(10) Pub. No.: US 2013/0068052 A1
(43) Pub. Date: Mar. 21, 2013

(54) BALL SCREW DEVICE WITH A RING TO RETAIN A DEVIATION ELEMENT FOR THE BALLS

(71) Applicant: Eric ALLEGRI, MONTMELIAN (FR)

(72) Inventor: Eric ALLEGRI, MONTMELIAN (FR)

(73) Assignee: AKTIEBOLAGET SKF, Goteborg (SE)

(21) Appl. No.: 13/623,180

(22) Filed: Sep. 20, 2012

(30) Foreign Application Priority Data
Sep. 21, 2011 (FR) 1158399
Mar. 22, 2012 (FR) 1252575

(51) Int. Cl. F16H 25/22

(52) U.S. Cl. CPC F16H 25/2219
USPC 74/89.34; 74/424.87

(57) ABSTRACT

The ball screw system comprises a screw having an external threading, a nut having an internal threading and a series of balls being engaged in said threadings to link the screw and the nut, the nut comprising ball recirculation means comprising at least one ball deflection element inserted into a through hole of the wall of the nut, from outside to inside as far as abutment means, in which the nut is equipped with a retaining ring which bears on a peripheral wall of this nut, over at least a part of its length, and which bears permanently against the bottom of at least one groove formed on an external face of said deflection element and in which the retaining ring is engaged.

### FIELD OF THE INVENTION

The present invention relates to the field of ball screw systems.

### BACKGROUND OF THE INVENTION

Ball screw systems comprise a screw having an external threading and a nut having an internal threading, which are linked by a series of balls, the nut being provided with a ball recirculation means which comprises ball deflection elements. According to one type of mounting, the deflection elements are inserted from outside, in abutment, into holes of the nut and are fixed to the latter by gluing.

The aim of the present invention is to propose another type of mounting, simpler to implement and more secure.

### SUMMARY OF THE INVENTION

A ball screw system is proposed which comprises a screw having an external threading, a nut having an internal threading and a series of balls being engaged in said threadings to link the screw and the nut, the nut comprising ball recirculation means comprising at least one ball deflection element inserted into a through hole of the wall of the nut, from outside to inside as far as abutment means.

The nut is equipped with a retaining ring which bears on a peripheral wall of this nut, over at least a part of its length, and which bears permanently against the bottom of at least one groove formed on an external face of said deflection element and in which the retaining ring is engaged, said permanent retaining ring being self-held and ensuring that the deflection element is held permanently in said through hole.

In one embodiment, the retaining ring is elastic.

The peripheral wall of the nut may have at least one groove in which said retaining ring can be engaged.

Said groove of the nut and said groove of the deflection element can form a peripheral channel.

According to a variant embodiment, said permanent retaining ring may be a closed ring surrounding the nut.

Said closed ring may be made of a synthetic material or of rubber.

According to another variant embodiment, said permanent retaining ring may be an open ring, this open ring being able to be extended by a folded-back end part, introduced into a recess of the nut at a distance from said through passage.

The recess receiving the folded-back end part of the open ring may be blind.

According to another variant embodiment, the open ring is extended, at each end, by a folded-back end part arranged in an associated recess of the nut at a distance from the through hole of said nut.

Preferentially, the circumferential distance separating the recesses of the nut is greater than the length of the open ring taken between the two end parts. The end parts of the open ring may be situated on one and the same side relative to a median radial plane of the system passing through the centre of the deflection element.

Advantageously, the open ring comprises a portion having an increased elasticity in the radial direction compared to the rest of said ring. Said portion may be diametrically opposite the opening delimited by the open ring. In one embodiment, said portion comprises at least one axial undulation. Alternatively, said portion comprises at least one radial undulation.

Said retaining ring may be completely inserted into a peripheral channel.

The bearing of the retaining element on the external face of the retaining element may be, peripherally, slightly protruding in relation to the bearing of the retaining element on the peripheral wall of the nut.

Said ball recirculation means may comprise two deflection elements held by two retaining rings, the deflection means forming two ball deflection passages, the nut having a longitudinal hole linking these deflection passages, the deflection elements being provided with internal fingers for extracting and reintroducing the balls at the ends of the ball circulation path in the nut.

According to another aspect of the invention, a linear actuator comprises a motor and a ball screw system as defined previously, the screw of said system being connected to the motor.

### BRIEF DESCRIPTION OF THE DRAWINGS

A ball screw system equipped with permanent retaining means will now be described as a nonlimiting example and illustrated by the appended drawings in which:

FIG. 1 represents a longitudinal cross section of a ball screw system;

FIG. 2 represents a perspective external view of the ball screw system of FIG. 1,

FIG. 3 represents a radial cross section of the ball screw system of FIG. 1, equipped with retaining means according to a first variant embodiment,

FIG. 4 represents a radial cross section of the ball screw system of FIG. 1, equipped with retaining means according to a second variant embodiment,

FIG. 5 represents a radial cross section of the ball screw system of FIG. 1, equipped with retaining means according to a third variant embodiment,

FIGS. 6 and 7 are side and front views of one of the retaining means of the system of FIG. 5,

FIGS. 8 and 9 are side and front views of a retaining means according to a fourth variant embodiment,

FIGS. 10 and 11 are side and front views of a retaining means according to a fifth variant embodiment, and

FIG. 12 is an axial cross section of a linear actuator.

### DETAILED DESCRIPTION OF THE INVENTION

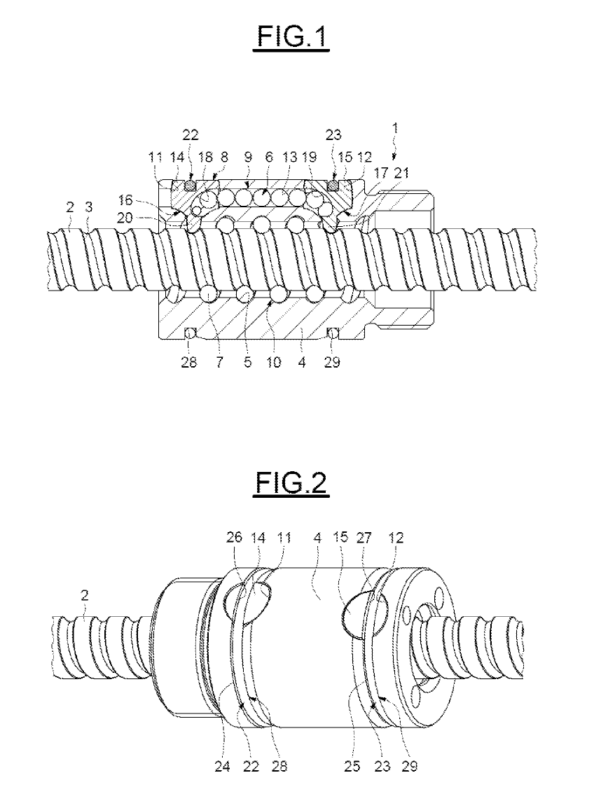

As illustrated in FIGS. 1 and 2, a ball screw system 1 comprises a longitudinal screw 2 having an external threading 3, a cylindrical nut 4 having an internal threading 5, the internal diameter of which is slightly greater than the external diameter of the screw 2, a series 6 of spherical balls 7 linking the screw 2 and the nut 4 and recirculation means 8 borne by the nut 4 and defining a recirculation channel 9.

The series of balls 7 is such that balls, engaged radially and partially in the threading of the screw 2 and partially in the threading 5 of the nut 4, circulate along a circulation path 10 in the nut 4, which can extend over several turns, while other balls circulate in the recirculation channel 9.

A rotation of the screw 2 in relation to the nut 4 is converted into a translational movement of one in relation to the other by the fact that balls 7 roll in the threadings 3 and 5 along the circulation path 10 and roll freely along the recirculation channel 9, respectively between the common ends of the circulation path 10 and of the recirculation channel 9.

According to the example represented, the recirculation means 8 defining the recirculation channel 9 are arranged as follows.

The wall of the nut 4 is provided with two secondary holes 11 and 12 passing radially through its thickness and spaced apart longitudinally and is provided with a longitudinal channel or hole 13 linking the holes 11 and 12.

The radial through holes 11 and 12 have pins or deflection elements 14 and 15 inserted into them which are, from outside to inside, held by abutment means 16 and 17 formed in the secondary holes 11 and 12 and on these deflection elements 14 and 15, for example by conjunction of toroidal or tapered forms. According to the example represented, the external faces of the deflection elements 14 and 15 are in the extension of the cylindrical external face of the nut 4. As a variant, the abutment means could be formed by or on the external surface of the nut.

The deflection elements 14 and 15 delimit, with the surfaces of the secondary holes 11 and 12, arc-shaped deflection passages 18 and 19 which open out inside the nut 4 in the area of the ends of the circulation path 10 and which, respectively, tangentially meet the ends of the longitudinal hole 13 of the nut 4, in such a way that the deflection passages 18 and 19 and the longitudinal hole 13 form the recirculation channel 9.

The deflection elements 14 and 15 are provided with internal fingers 20 and 21 for extracting and reintroducing the balls 7 at the ends of the circulation path 10. These fingers 20 and 21 are engaged in the external threading 3 of the screw 2, so that, upon the rotation of the screw 2 in relation to the nut 4, the balls 7, one after the other, are extracted by one of the fingers 20 or 21 at one of the ends of the circulation path 10, circulate freely in the recirculation channel 9, and are reintroduced by the other finger 20 or 21 at the other end of the circulation path 10.

The nut 4 is equipped with permanent retaining means 22 and 23 ensuring that the deflection elements 14 and 15 are permanently held, from outside, in the secondary holes 11 and 12, in the direction of the abutment means 16 and 17.

The external face of the nut 4 has external peripheral grooves 24 and 25, the ends of which open out into the secondary holes 11 and 12 and the external faces of the deflection elements 14 and 15 have external grooves 26 and 27 which are in the extension of the grooves 24 and 25, so that, on the one hand, the groove 24 of the nut 4 and the groove 26 of the deflection element 14 form a peripheral channel 28 and, on the other hand, the groove 25 of the nut 4 and the groove 27 of the deflection element 15 form a peripheral channel 29.

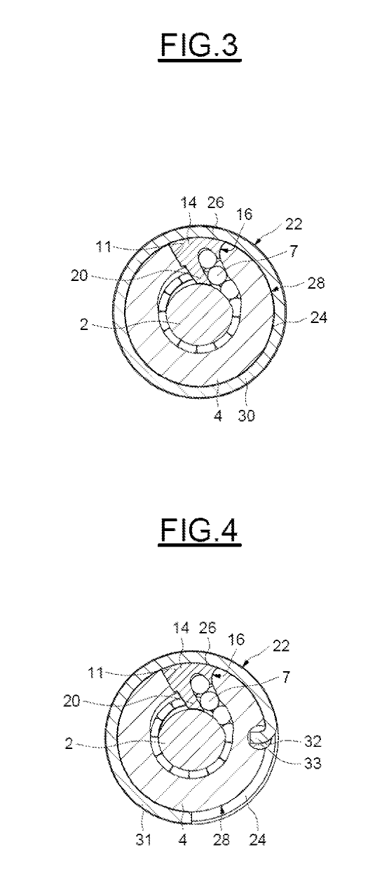

According to an example illustrated in FIG. 3, the permanent retaining means 22 and 23 are formed by identical closed toric rings 30 surrounding the nut 4, which are arranged and extend in the peripheral channels 28 and 29, bearing against the bottom thereof. These closed rings 30 are made of an elastic material and are taut, so that they are self-held in the peripheral channels 28 and 29.

The closed rings 30, permanently bearing against the bottom of the grooves 26 and 27, exert permanent forces on the deflection elements 14 and 15, from outside to inside, towards the abutment means 16 and 17, so that the deflection elements 14 and 15 are held permanently and avoiding any vibration. According to a variant embodiment, in order to be sure that there is a permanent contact of the elastic rings 30 on the deflection elements 14 and 15, the bottoms of the grooves 26 and 27, at least over a part of their length, could be designed to protrude outward relative to the circumference of the bottoms of the grooves 24 and 25 of the nut 4.

For their mounting, the closed rings 30 are enlarged by radial deformation against their elasticity, then they are made to slide longitudinally around the nut 4, and they are allowed to be introduced into the peripheral channels 28 and 29 under the effect of their elasticity, i.e. by elastic return.

The sections of the peripheral channels 28 and 29 and of the closed rings 30 can be such that the closed rings 30 occupy the peripheral channels 28 and 29 and are completely inserted into the latter so that the closed rings 30 do not extend outward relative to the external faces of the nut 4 and of the deflection elements 14 and 15.

The closed rings 30 can be made of a synthetic material, or of rubber, or even of metal. In the latter case, the mounting can be done by heating the metal closed rings 30.

According to another example illustrated in FIG. 4, in which the identical elements are given the same references, the permanent retaining means 22 and 23 are formed by open rings 31 in the circumferential direction which surround the nut 4 and which are arranged and extend in the peripheral channels 28 and 29 over approximately three quarters of the perimeter of the nut 4, bearing against the bottom of these channels 28 and 29. These open rings 31 are identical to one another and made of an elastic material, for example of a sprung metal material, and are self-held in the peripheral channels 28 and 29 under the effect of their elasticity. The open rings 31 can also be made of synthetic material or of rubber.

Each open ring 31 is, at one of its ends, extended by an end part 32 folded radially inward, introduced into a blind hole or recess 33 of the nut 4 formed in the bottom of the associated peripheral channel 28. The blind recess 33 is at a distance from the secondary hole 11, for example by approximately a quarter turn in the clockwise direction. The other end of each open ring 31 is, for example, diametrically opposite the associated deflection element 14, so that the deflection element 14 is completely covered and passed through by the open ring 31.

The open rings 31, permanently bearing against the bottom of the grooves 26 and 27, exert permanent forces on the deflection elements 14 and 15, from outside to inside, towards the abutment means 16 and 17, so that the deflection elements 14 and 15 are held permanently and avoiding any vibration. According to a variant embodiment, in order to be sure that there is a permanent contact between the open rings 31 and the deflection elements 14 and 15, the bottom of the grooves 26 and 27 of the deflection elements 14 and 15 could be designed, over at least a part of their length, to protrude slightly relative to the circumference of the peripheral grooves 24 and 25 of the nut 4.

The mounting of each open ring 31 can be of “clip” type. For this, the folded part 32 is introduced into the recess 33 and pressure is applied to the ring radially. The latter is deformed elastically so that ultimately it is housed in the corresponding channel 28, 29 and almost reverts to its initial form.

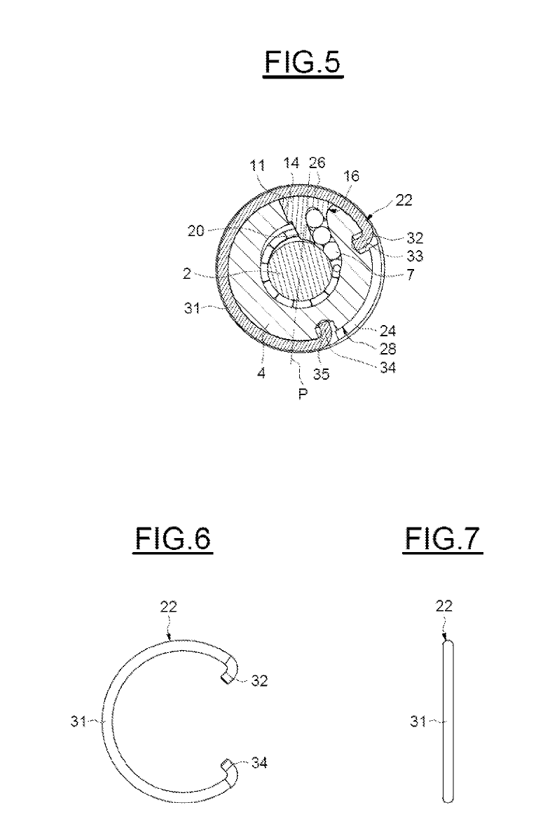

In the exemplary embodiment illustrated in FIGS. 5 to 7, in which the identical elements are given the same references, the end of the open ring 31 situated opposite the end part 32 is extended by an end part 34 folded radially inward and introduced into a blind recess 35 of the nut 4 formed in the bottom of the associated peripheral channel 28. The open ring 31 is extended, at each circumferential end, by an end part 32, 34 extending inward and mounted in the associated recess 33, 35. The end parts 32, 34 are here identical.

In the exemplary embodiment illustrated, the blind recess 33 is at a distance from the secondary hole 11 in the circumferential direction by a little less than a quarter turn in the clockwise direction. The recess 35 into which the end part 34 of the open ring extends is situated on the nut 4 so that the open ring 31 totally covers and passes through the deflection element 14. In the exemplary embodiment illustrated, the recess 35 is at a distance from the recess 33 in the circumferential direction by less than a quarter turn in the clockwise direction. The circumferential distance separating the recesses 33, 35 of the nut is greater than the length of the open ring 31 taken between the two end parts 32, 34 in order for said ring to be held taut in the mounted position.

Advantageously, the end part 34 of the ring is offset in the circumferential direction on the side of the end part 32 relative to a median radial plane P of the system passing through the centre of the deflection element 14. The two end parts 32, 34 of the open ring 31 are situated on one and the same side of the radial plane P.

Compared to the preceding exemplary embodiments, the open ring 31 presents the advantage of being more difficult to dismantle even by a significant radial thrust exerted on the deflection elements 14 and 15, for example during the recirculation of the balls 7. This is made possible by the provision, at each circumferential end of the ring 31, of an end part 32, 34 forming a radial snug mounted in a recess 33, of the nut. This retaining of the open ring 31 on the nut 4 is also favoured by the arrangement of the end parts 32, 34 relative to the radial plane P passing through the centre of the deflection element 14.

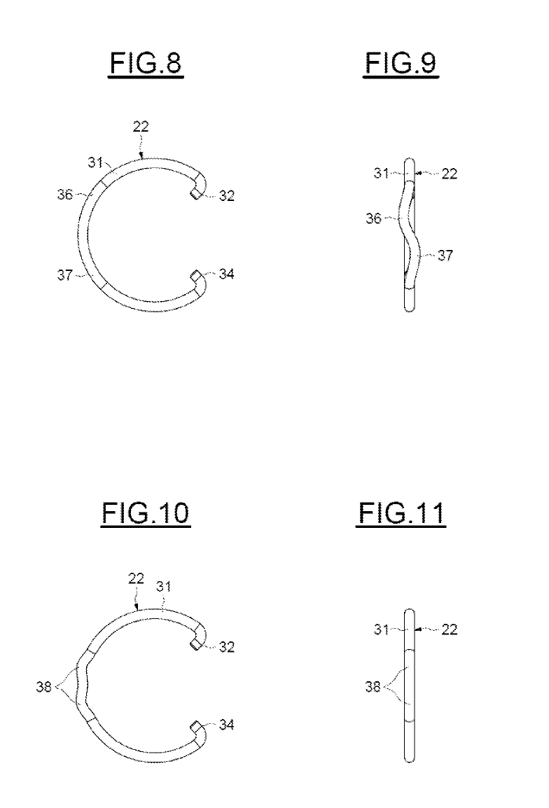

In the exemplary embodiment illustrated in FIGS. 8 and 9, in which the identical elements are given the same references, the open ring 31 comprises first and second undulations 36, 37 extending axially in opposite directions. The first undulation 36 is extended in the circumferential direction by the second undulation 37 extending axially on the side opposite the undulation 36. The undulations 36, 37 of the open ring 31 are diametrically opposite the opening delimited in the circumferential direction by the end parts 32, 34. The undulations 36, 37 form, on the open ring 31, a portion exhibiting an increased elasticity in the radial direction compared to the rest of the ring.

When mounting the open ring 31 on the nut 4, the procedure is as follows. In order to introduce the folded parts 32, 34 of the ring into the associated recesses 33, 35 of the nut, the undulations 36, 37 are stretched radially outward. Then, the undulations 36, 37 are released and tend, by elastic return, to resume their initial form and exert a radial pressure inward on the nut 4 and on the associated deflection element. This favours the tensioning of the open ring 31.

The exemplary embodiment illustrated in FIGS. 10 and 11, in which the identical elements are given the same references, differs from the preceding embodiment in that the open ring 31 comprises two adjacent undulations 38 extending radially outward. The undulations 38 are diametrically opposite the opening of the ring by the end parts 32, 34. The undulations 38 form, on the open ring 31, a portion exhibiting an increased elasticity in the radial direction compared to the rest of the ring. As a variant, it could even be possible to provide undulations extending radially inward.

In the preceding two embodiments, each open ring comprises two undulations extending radially or axially. As a variant, it could of course be possible to provide a different number of undulations on each ring, for example one undulation or even three undulations or more.

As in the first exemplary embodiment illustrated, the sections of the peripheral channels 28 and 29 and of the open rings 31 described in the other embodiments can be such that the open rings 31 occupy the peripheral channels 28 and 29 and are completely inserted therein so that the open rings 31 do not extend outward relative to the external faces of the nut 4 and of the deflection elements 14 and 15.

According to the examples which have just been described, the nut and the deflection elements have grooves which determine peripheral channels receiving the retaining rings. However, according to a variant embodiment, it could be only the nut that has grooves receiving the retaining rings, the retaining rings then bearing on the external surfaces of the retaining elements. According to another variant embodiment, it could be only the external surfaces of the deflection elements, protruding relative to the peripheral surface of the nut, that have grooves receiving the retaining rings, the retaining rings then bearing directly on the peripheral surface of the nut.

The examples described give the result that the proposed retaining rings make it possible to avoid the ejection of the deflection elements.

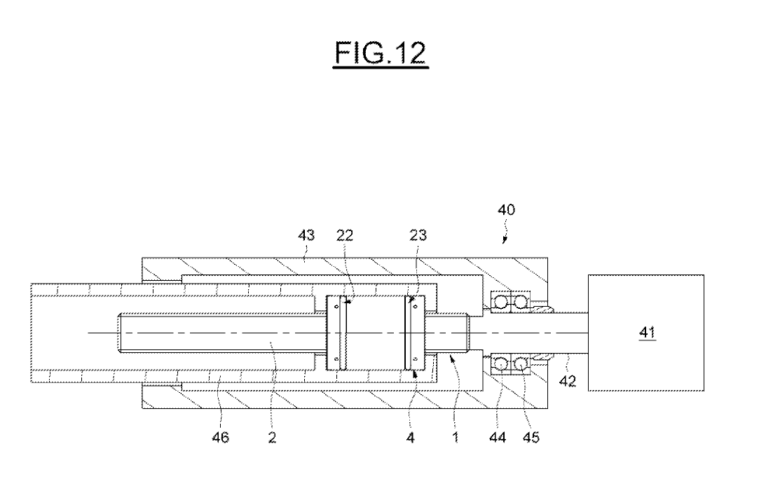

With reference to FIG. 12, a specific application of the ball screw system 1 in a linear actuator will now be described. The linear actuator 40 comprises a driving motor 41 provided with an output shaft 42 connected by appropriate means (not represented) to the screw of the system. The output shaft 42 and the screw 2 are mounted in a housing 43 of the actuator via two rolling bearings 44 and 45. The nut 4 of the system supports a tubular sleeve 46 of the actuator which can be used to displace loads. When the shaft 42 and the screw 2 rotate, the sleeve 46 is displaced axially in translation.

1. A ball screw system comprising:
a screw having an external threading,
a nut having an internal threading and
a series of balls engaged in the threadings to link the screw and the nut, and wherein
the nut provides ball recirculation means including at least one ball deflection element inserted into a through hole of the wall of the nut, from outside to inside as far as abutment means, and wherein
the nut is equipped with a retaining ring which bears on a peripheral wall of the nut, over at least a part of its length, and which bears permanently against the bottom of at least one groove formed on an external face of the deflection element and where the retaining ring is engaged, and wherein
the permanent retaining ring is self-held and ensures that the deflection element is held permanently in the through hole.

2. The system according to claim 1, wherein the retaining ring is elastic.

3. The system according to claim 1, wherein the peripheral wall of the nut has at least one groove in which said retaining ring is engaged.

4. The system according to claim 3, wherein the groove of the nut and the groove of the deflection element form a peripheral channel.

5. The system according to claim 1, wherein the retaining ring is a closed ring surrounding the nut.

6. The system according to claim 5, wherein the closed ring is made of a synthetic material or of rubber.

7. The system according to claim 1, wherein the permanent retaining ring is an open ring, the open ring being extended by a folded-back end part, introduced into a recess of the nut at a distance from the through hole of said nut.

8. The system according to claim 7, wherein the recess receiving the folded-back end part of the open ring is blind.

9. The system according to claim 7, wherein the open ring is extended, at each end, by a folded-back end part arranged in an associated recess of the nut at a distance from the through hole of said nut.

10. The system according to claim 9, wherein the circumferential distance separating the recesses of the nut is greater than the length of the open ring taken between the two end parts.

11. The system according to claim 9, wherein the end parts of the open ring are situated on one and the same side relative to a median radial plane (P) of the system passing through the centre of the deflection element.

12. The system according to claim 9, wherein the open ring further comprises a portion having an increased elasticity in the radial direction compared to the rest of the ring.

13. The system according to claim 12, wherein the portion is diametrically opposite the opening delimited by the open ring

14. The system according to claim 12, wherein the portion further comprises at least one axial undulation.

15. The system according to claim 12, wherein the portion further comprises at least one radial undulation.

16. The system according to claim 1, wherein the retaining ring is completely inserted into a peripheral channel.

17. The system according to claim 1, wherein the bearing of the retaining element on the external face of the retaining element is, peripherally, slightly protruding in relation to the bearing of the retaining element on the peripheral wall of the nut.

18. The system according to claim 1, wherein the ball recirculation means comprises two deflection elements held by two retaining rings, and wherein
the deflection means forms two ball deflection passages, and wherein
the nut has a longitudinal hole that links the deflection passages, and wherein
the deflection elements are provided with internal fingers for extracting and reintroducing the balls at the ends of the ball circulation path in the nut.

19. A linear actuator comprising:
a motor and
a ball screw system including:
a screw having an external threading,
a nut having an internal threading and
a series of balls engaged in the threadings to link the screw and the nut, and wherein
the nut provides ball recirculation means including at least one ball deflection element inserted into a through hole of the wall of the nut, from outside to inside as far as abutment means, and wherein
the nut is equipped with a retaining ring which bears on a peripheral wall of the nut, over at least a part of its length, and which bears permanently against the bottom of at least one groove formed on an external face of the deflection element and where the retaining ring is engaged, and wherein
the permanent retaining ring is self-held and ensures that the deflection element is held permanently in the through hole, and wherein
the screw of the system is connected to the motor.
